(19) United States
(12) Patent Application Publication
(10) Pub. No.: US 2012/0273250 A1
(43) Pub. Date: Nov. 1, 2012

(54) INSULATION COMPOSITIONS

(75) Inventors: Jianmin LIU, Carmel, IN (US); Sean W. Culligan, Zionsville, IN (US); Vijay Mhetar, Carmel, IN (US)

(73) Assignee: General Cable Technologies Corporation, Highland Heights, KY (US)

(21) Appl. No.: 13/457,706

(22) Filed: Apr. 27, 2012

Related U.S. Application Data
(60) Provisional application No. 61/480,737, filed on Apr. 29, 2011.

(51) Int. Cl. C08L 27/24; H01B 3/30; C08K 5/524

(52) U.S. Cl. 174/110 SR; 525/185; 524/153

(57) ABSTRACT

The present invention relates to insulation compositions. In an object of the present invention, the compositions contain a fluoropolymer, a poly(arylene ether) and a styrene block copolymer. The compositions maintain substantially similar electrical properties and flame retardancy, and have reducing cost and density when compared to fluoropolymers alone.

### CROSS-REFERENCE TO RELATED APPLICATION

The present application is related to and claims the benefit of U.S. Provisional Patent Application No. 61/480,737, filed Apr. 29, 2011, the disclosure of which is hereby incorporated by reference in its entirety.

### BACKGROUND OF THE INVENTION

When the fire reaches the plenum space, and especially if flammable material occupies the plenum, the fire can spread quickly throughout the entire floor of the building. The fire could travel along the length of cables which are installed in the plenum if the cables are not rated for plenum use, i.e., do not possess the requisite flame and smoke retardation characteristics. Also, smoke can be conveyed through the plenum to adjacent areas and to other floors with the possibility of smoke permeation throughout the entire building.

Because of the possibility of flame spread and smoke evolution, as a general rule, the National Electrical Code (NEC) requires that power-limited cables in plenums be enclosed in metal conduits. However, the NEC permits certain exceptions to this requirement. For example, cables without metal conduits are permitted, provided that such cables are tested and approved by an independent testing agent, such as Underwriters Laboratories (UL), as having suitably low flame spread and smoke generating or producing characteristics. The flame spread and smoke production of cables are measured using the UL 910, also known as the “Steiner Tunnel,” standard test method or, more recently, the NFPA 262 flame test for fire and smoke retardation characteristics of electrical and optical fiber cables used in air handling spaces, i.e., plenums.

To meet UL910 or NFPA 262 requirements, communication cables generally use fluoropolymers as wire covers (insulations or jackets). However, fluoropolymers are expensive and significantly raise the cost of the cable. Therefore, there remains a need to produce cable cover materials that have similar fire and smoke properties as fluoropolymers, but at a lower cost.

### SUMMARY OF THE INVENTION

The present invention relates to insulation compositions. In an object of the present invention, the compositions contain a fluoropolymer, a poly(arylene ether) and a styrene block copolymer. The compositions maintain substantially similar electrical properties and flame retardancy, and have reducing cost and density when compared to fluoropolymers alone. The fluoropolymer is preferably present at least about 50 percent by weight of the composition, more preferably at least about 60 percent, and most preferably at least about 80 percent. The poly(arylene ether) is preferably present at about 1 to about 30 percent by weight of the composition. The styrene block copolymer is preferably present at about 1 to about 20 percent by weight of the composition. In preferred embodiments, the composition is formed such that the fluoropolymer forms the continuous phase while the a poly(arylene ether) and a styrene block copolymer form the dispersed phase. In another preferred embodiment, the composition also contains a filler which is surface treated, such as by silanization, to improved its compatibility with the polymers.

Another object of the present invention relates to cables, especially plenum cables, containing a wire that is covered with the insulation composition.

A yet another object of the present invention relates to method for making the insulation composition.

### DETAILED DESCRIPTION OF THE INVENTION

The present invention relates to insulation compositions containing a fluoropolymer, a poly(arylene ether) and a styrene block copolymer. Fluoropolymers are well-known in the art and are disclosed, for example, in U.S. Pat. Nos. RE40,516, 6,753,478, 4,963,609, and 4,957,961, which are incorporated herein by reference. For the present invention, the preferred fluoropolymers are tetrafluorethylenes, including FEP, ETFE, ETEP, MFA, PFA, PVDF, THV. The insulation composition may comprise the fluoropolymer in an amount of at least about 50 weight percent (wt %) based on the weight of the composition, preferably at least about 60 wt %, and more preferably at least about 80 wt %. Preferably, the composition contains FEP at least about 50 wt %.

As used herein, a “poly(arylene ether)” comprises a plurality of structural units of the formula (I):

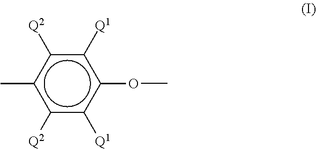

wherein for each structural unit, each Q¹ and Q² is independently hydrogen, halogen, primary or secondary lower alkyl (e.g., an alkyl containing 1 to 7 carbon atoms), phenyl, haloalkyl, aminoalkyl, alkenylalkyl, alkynylalkyl, hydrocarbonoxy, aryl and halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are tetramethyl diphenylquinone (TMDQ) end groups, typically obtained from reaction mixtures in which tetramethyl diphenylquinone by-product is present.

The poly(arylene ether) may be in the form of a homopolymer; a copolymer; a graft copolymer; an ionomer; or a block copolymer; as well as combinations comprising at least one of the foregoing. Poly(arylene ether) includes polyphenylene ether comprising 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol, 2,3,6-trimethylphenol and combinations of 2,6-xylenol and 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

In one embodiment, the poly(arylene ether) comprises a capped poly(arylene ether). The terminal hydroxy groups may be capped with a capping agent via an acylation reaction, for example. The capping agent chosen is preferably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. In one embodiment the capping agents are selected from salicylic carbonate and the polysalicylates, especially linear polysalicylates, and combinations comprising one of the foregoing. Exemplary capped poly(arylene ether) and their preparation are described in U.S. Pat. No. 4,760,118 to White et al. and U.S. Pat. No. 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), can be susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine (salicylamide). The removal of the amino group and the capping provides a poly(arylene ether) that is more stable to high temperatures, thereby resulting in fewer degradative products, such as gels, during processing of the poly(arylene ether).

The poly(arylene ether) can have a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s has an initial intrinsic viscosity greater than 0.3 deciliters per gram (dl/g), as measured in chloroform at 25° C. Initial intrinsic viscosity is defined as the intrinsic viscosity of the poly(arylene ether) prior to melt mixing with other components of the composition. As understood by one of ordinary skill in the art the viscosity of the poly(arylene ether) may be up to 30% higher after melt mixing. The percentage of increase can be calculated by (final intrinsic viscosity after melt mixing−initial intrinsic viscosity before melt mixing)/initial intrinsic viscosity before melt mixing. Determining an exact ratio, when two initial intrinsic viscosities are used, will depend somewhat on the exact intrinsic viscosities of the poly(arylene ether) used and the ultimate physical properties that are desired.

The poly(arylene ether) used to make the thermoplastic composition can be substantially free of visible particulate impurities. In one embodiment, the poly(arylene ether) is substantially free of particulate impurities greater than 15 micrometers in diameter. As used herein, the term “substantially free of visible particulate impurities” when applied to poly(arylene ether) means that a ten gram sample of a poly(arylene ether) dissolved in fifty milliliters of chloroform (CHCl₃) exhibits fewer than 5 visible specks when viewed in a light box with the naked eye. Particles visible to the naked eye are typically those greater than 40 micrometers in diameter. As used herein, the term “substantially free of particulate impurities greater than 15 micrometers” means that of a forty gram sample of poly(arylene ether) dissolved in 400 milliliters of CHCl₃, the number of particulates per gram having a size of 15 micrometers is less than 50, as measured by a Pacific Instruments ABS2 analyzer based on the average of five samples of twenty milliliter quantities of the dissolved polymeric material that is allowed to flow through the analyzer at a flow rate of one milliliter per minute (plus or minus five percent).

The composition may comprise the poly(arylene ether) in an amount of about 1 to about 30 wt % based on the weight of the composition. Preferably, the composition contains poly(phenyl ether) or poly(2,6-dimethyl-1,4-phenylene ether) at about 1 to about 30 wt %.

Any styrene block copolymer can be used for the present invention. As fluoropolymer and poly(arylene ether) are generally immiscible, the styrene block copolymer serves primarily as a compatibilizer and is added to the blend to stabilize it. Preferably, the styrene copolymer used in the present composition 1) has a styrene content of 55 percent (by weight base on the total styrene copolymer) or greater; 2) contains a random arrangement of styrene and at least one other block polymer; and/or 3) contains a triblock having styrene at the two ends of the triblock and alkylene-styrene as the center block.

In an embodiment, the styrene content of the copolymer is at least 55 percent (by weight of the total styrene copolymer), preferably at least 60 percent. In that embodiment, the styrene copolymer can be any available styrene copolymer as long as the high percentage of styrene content is met. The styrene copolymer can include, for example, an SE block copolymer made from styrene and ethylene, an SB block copolymer made from styrene (S) and butadiene (B), an SEB block copolymer made by saturating the unsaturated double bonds in the above butadiene block by hydrogenation, and an SEP block copolymer made from styrene (S) and ethylene/propylene (EP). Other styrene copolymers include a tri-block with styrene at the ends of the tri-block, such as SES, SEBS, SBS, and SEPS. The preferred styrene copolymer for this embodiment is SEBS, SEPS, SBS, and/or SE.

In another embodiment, the styrene copolymer contains a random arrangement of styrene and at least one other block polymer which can be, but is not limited to, ethylene, butylene, propylene and isoprene. In a preferred embodiment, the styrene copolymer is a random arrangement of styrene and ethylene.

In yet another embodiment, the styrene copolymer is a triblock having the general formula S-AS-S, where S is styrene and A is an alkylene or mixture of different alkylenes. In this embodiment, the two end blocks are pure styrene while the middle block is a styrene copolymer. The alkylene or mixture of different alkylenes can be, but is not limited to ethylene (E), butylene (B), ethylene/butylene (EB), and/or ethylene/propylene (EP). The preferred triblock copolymer has the general formula S-BES-S, where the two end blocks are pure styrene and the middle block is butylene/ethylene/styrene. The composition may contain the styrene copolymer at about 1 to about 20 wt % of the total composition.

The insulation compositions may optionally be blended with various additives that are generally used in insulted wires or cables, such as an antioxidant, a metal deactivator, a flame retarder, a dispersant, a colorant, a filler, a stabilizer, a peroxide, and/or a lubricant, in the ranges where the object of the present invention is not impaired. The additives should be less than about 5 percent (by weight based on the total polymer), preferably less than about 3 percent, more preferably less than about 0.6 percent.

The antioxidant can include, for example, amine-antioxidants, such as 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis[3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5 bis(1,1 dimethylethyl)-4-hydroxy benzenepropanoic acid, 3,5-bis(1,1-dimethylethyl)-4-hydroxy-C13-15 branched and linear alkyl esters, 3,5-di-tert-butyl-4-hydroxyhydrocinnamic acid C7-9-Branched alkyl ester, 2,4-dimethyl-6-t-butylphenol Tetrakis{methylene3-(3′,5′-ditert-butyl-4′-hydroxyphenol)propionate}methane or Tetrakis{methylene3-(3′,5′-ditert-butyl-4′-hydrocinnamate}methane, 1,1,3-tris(2-methyl-4hydroxyl5butylphenyl)butane, 2,5,di t-amyl hydroquinone, 1,3,5-trimethyl-2,4,6-tris(3,5-di tert butyl-4-hydroxybenzyl)benzene, 1,3,5-tris(3,5-di tert butyl-4-hydroxybenzyl)isocyanurate, 2,2-Methylene-bis-(4-methyl-6-tert butyl-phenol), 6,6′-di-tert-butyl-2,2′-thiodi-p-cresol or 2,2′-thiobis(4-methyl-6-tert-butylphenol), 2,2-ethylenebis(4,6-di-t-butylphenol), triethyleneglycol bis{3-(3-t-butyl-4-hydroxy-5-methylphenyl)propionate}, 1,3,5-tris(4-tert butyl3hydroxy-2,6-dimethylbenzyl)-1,3,5-triazine-2,4,6-(1H,3H,5H)trione, 2,2-methylenebis{6-(1-methylcyclohexyl)-p-cresol}; and/or sulfur antioxidants, such as bis(2-methyl-4-(3-n-alkylthiopropionyloxy)-5-t-butylphenyl)sulfide, 2-mercaptobenzimidazole and its zinc salts, and pentaerythritol-tetrakis(3-lauryl-thiopropionate). The preferred antioxidant is thiodiethylene bis[3-[3,5-di-tert-butyl-4-hydroxyphenyl]propionate which is available commercially as Irganox® 1035.

The metal deactivator, can include, for example, N,N′-bis(3-(3,5-di-t-butyl-4-hydroxyphenyl)propionyl)hydrazine, 3-(N-salicyloyl)amino-1,2,4-triazole, and/or 2,2′-oxamidobis-(ethyl 3-(3,5-di-t-butyl-4-hydroxyphenyl)propionate).

The flame retarder, can include, for example, halogen flame retarders, such as tetrabromobisphenol A (TBA), decabromodiphenyl oxide (DBDPO), octabromodiphenyl ether (OBDPE), hexabromocyclododecane (HBCD), bistribromophenoxyethane (BTBPE), tribromophenol (TBP), ethylenebistetrabromophthalimide, TBA/polycarbonate oligomers, brominated polystyrenes, brominated epoxys, ethylenebispentabromodiphenyl, chlorinated paraffins, and dodecachlorocyclooctane; inorganic flame retarders, such as aluminum hydroxide and magnesium hydroxide; and/or phosphorus flame retarders, such as phosphoric acid compounds, polyphosphoric acid compounds, and red phosphorus compounds.

The filler, can be, for example, carbons, clays, zinc oxide, tin oxides, magnesium oxide, molybdenum oxides, antimony trioxide, silica, talc, potassium carbonate, magnesium carbonate, and/or zinc borate. In certain embodiments, it is advantageous to treat the filler to make it more compatible with and to uniformly disperse in the polymer. For example, clays can be surface treated with silane (e.g. fluorosilane) to improve the filler-polymer interaction and to improve the filler dispersion in the polymer matrix. A preferred filler for the present invention is a microoxide made by Elkem Silicon Materials and marketed as SIDISTAR® T. That microoxide is a spherically-shaped amorphous silicon dioxide additive designed for polymer applications. The average primary particle size of SIDISTAR® T is 150 nm. Depending on the selected polymer, the microoxide filler may provide increased flame retardancy, greater stiffness, improved melt flow, improved surface finish, improved melt strength, improved dryblend flow, impact strength, and lower cost. In the mixing process, SIDISTAR® T improves the dispersion of all compound ingredients providing well-balanced physical properties in the final insulation. Because it is dispersed as primarily spherical particles, it reduces internal friction and allows higher extrusion or injection speed as the result of better melt flow and therefore significant cost savings. Dispersion down to primary particles within the matrix enables a very fine cell formation, resulting in a reduction of high molecular weight processing aid and therefore much reduced raw material costs. Table 1 below provides the product specification of SIDISTAR® T 120.

TABLE 1

| Properties | Unit | Limits |
|---|---|---|
| SiO₂ | % | 96.0-99.0 |
| (Silicon dioxide, amorphous) | | |
| C | % | ≦0.20 |
| (Carbon) | | |
| Fe₂O₃ | % | ≦0.25 |
| (Iron oxide) | | |
| H₂O | % | ≦0.8 |
| Loss on Ignition | % | ≦0.60 |
| (L.O.I.) @ 950° C. | | |
| Coarse Particles | % | ≦0.10 |
| (325 mesh) | | |
| pH-value | | 7.0-9.0 |
| Bulk Density | kg/m³ | 400-700 |
| Specific Surface Area | m²/g | 20 |
| (BET) | | |
| L-value | % | ≧89.5 |
| Median particle size | μm | 0.15 |
| Density | g/cm³ | 2.2 |

The stabilizer, can be, but is not limited to, hindered amine light stabilizers (HALS) and/or heat stabilizers. The HALS can include, for example, bis(2,2,6,6-tetramethyl-4-piperidyl)sebaceate (Tinuvin® 770); bis(1,2,2,6,6-tetramethyl-4-piperidyl)sebaceate+methyl1,2,2,6,6-tetramethyl-4-piperidyl sebaceate (Tinuvin® 765); 1,6-Hexanediamine, N,N′-Bis(2,2,6,6-tetramethyl-4-piperidyl)polymer with 2,4,6 trichloro-1,3,5-triazine, reaction products with N-butyl-2,2,6,6-tetramethyl-4-piperidinamine (Chimassorb® 2020); decanedioic acid, Bis(2,2,6,6-tetramethyl-1-(octyloxy)-4-piperidyl)ester, reaction products with 1,1-dimethylethylhydroperoxide and octane (Tinuvin® 123); triazine derivatives (Tinuvin® NOR371); butanedioc acid, dimethylester, polymer with 4-hydroxy-2,2,6,6-tetramethyl-1-piperidine ethanol (Tinuvin® 622); 1,3,5-triazine-2,4,6-triamine,N,N′″-[1,2-ethane-diyl-bis[[[4,6-bis-[butyl(1,2,2,6,6-pentamethyl-4-piperidinyl)amino]-1,3,5-triazine-2-yl]imino-]-3,1-propanediyl]]bis[N′,N″-dibutyl-N′,N″bis(2,2,6,6-tetramethyl-4-piperidyl) (Chimassorb® 119); and/or bis(1,2,2,6,6-pentamethyl-4-piperidinyl) sebacate (Songlight® 2920); poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb®944); Benzenepropanoic acid, 3,5-bis(1,1-dimethyl-ethyl)-4-hydroxy-.C7-C9 branched alkyl esters (Irganox® 1135); and/or Isotridecyl-3-(3,5-di-tert-butyl-4-hydroxyphenyl) propionate (Songnox® 1077 LQ). The preferred HALS is bis(1,2,2,6,6-pentamethyl-4-piperidinyl) sebacate commercially available as Songlight 2920.

The heat stabilizer can be, but is not limited to, 4,6-bis(octylthiomethyl)-o-cresol (Irgastab KV-10); dioctadecyl 3,3′-thiodipropionate (Irganox PS802); poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb®944); Benzenepropanoic acid, 3,5-bis(1,1-dimethyl-ethyl)-4-hydroxy-.C7-C9 branched alkyl esters (Irganox® 1135); Isotridecyl-3-(3,5-di-tert-butyl-4-hydroxyphenyl) propionate (Songnox® 1077 LQ). If used, the preferred heat stabilizer is 4,6-bis(octylthiomethyl)-o-cresol (Irgastab KV-10); dioctadecyl 3,3′-thiodipropionate (Irganox PS802) and/or poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb®944).

The compositions of the invention can be prepared by blending the melt, blending the fluoropolymer, poly(arylene ether), styrene copolymer, and optional additives by use of conventional masticating equipment, for example, a rubber mill, Brabender Mixer, Banbury Mixer, Buss-Ko Kneader, Farrel continuous mixer or twin screw continuous mixer. The additives are preferably premixed before addition to the base polyolefin polymer. Mixing times should be sufficient to obtain homogeneous blends. All of the components of the compositions utilized in the invention are usually blended or compounded together prior to their introduction into an extrusion device from which they are to be extruded onto an electrical conductor.

After the various components of the composition are uniformly admixed and blended together, they are further processed to fabricate the cables of the invention. Prior art methods for fabricating polymer cable insulation or cable jacket are well known, and fabrication of the cable of the invention may generally be accomplished by any of the various extrusion methods.

In a typical extrusion method, an optionally heated conducting core to be coated is pulled through a heated extrusion die, generally a cross-head die, in which a layer of melted polymer is applied to the conducting core. Upon exiting the die, if the polymer is adapted as a thermoset composition, the conducting core with the applied polymer layer may be passed through a heated vulcanizing section, or continuous vulcanizing section and then a cooling section, generally an elongated cooling bath, to cool. Multiple polymer layers may be applied by consecutive extrusion steps in which an additional layer is added in each step, or with the proper type of die, multiple polymer layers may be applied simultaneously.

The conductor of the invention may generally comprise any suitable electrically conducting material, although generally electrically conducting metals are utilized. Preferably, the metals utilized are copper or aluminum. In power transmission, aluminum conductor/steel reinforcement (ACSR) cable, aluminum conductor/aluminum reinforcement (ACAR) cable, or aluminum cable is generally preferred.

Without further description, it is believed that one of ordinary skill in the art can, using the preceding description and the following illustrative example, make and utilize the compounds of the present invention and practice the claimed methods. The following example is given to illustrate the present invention. It should be understood that the invention is not to be limited to the specific conditions or details described in this example.

### Example

Tables 1 and 2 show the different compositions produced and tested:

TABLE 1

| Ingredients | FEP9475 | FT5A1 | FT5A2 | FT5A3 | FT5A4 | FT5A5 | FT5A6 | FT5A7 |
|---|---|---|---|---|---|---|---|---|
| FEP 9475 | 100 | 89.80 | 87.55 | 85.30 | 83.16 | 81.90 | 75.89 | 87.55 |
| PPE 646-111 | | 10.00 | 9.75 | 9.50 | 9.26 | 14.25 | 19.01 | 9.75 |
| Irganox 1010 | | | | | | | | |
| Irgafos 168 | | 0.10 | 0.10 | 0.10 | 0.10 | 0.10 | 0.10 | 0.10 |
| Zinc Oxide | | 0.10 | 0.10 | 0.10 | 0.10 | 0.10 | 0.10 | 0.10 |
| Kraton G1651 | | | 2.50 | | 2.37 | 3.65 | 4.90 | |
| Sidistar T120 | | | | 5.00 | 5.00 | | | |
| Kraton G1650 | | | | | | | | 2.50 |
| Tuftec H1043 | | | | | | | | |
| Total | 100 | 100.00 | 100.00 | 100.00 | 100.00 | 100.00 | 100.00 | 100.00 |

TABLE 2

| Ingredients | FT5A8 | FT5A9 | FT5A10 | FT5A11 | FT5A12 | FTA13 | FT5BA |
|---|---|---|---|---|---|---|---|
| FEP 9475 | 83.16 | 87.55 | 81.90 | 87.55 | 87.55 | 90.00 | 85.00 |
| PPE 646-111 | 9.26 | 8.25 | 14.25 | 9.75 | 8.25 | | 10.50 |
| Irganox 1010 | | | | | | | 0.20 |
| Irgafos 168 | 0.10 | 0.10 | 0.10 | 0.10 | 0.10 | | 0.10 |
| Zinc Oxide | 0.10 | 0.10 | 0.10 | 0.10 | 0.10 | | 0.20 |
| Kraton G1651 | | | | | | | 4.00 |
| Sidistar T120 | 5.00 | | | | | | |
| Kraton G1650 | 2.37 | 4.00 | 3.65 | | | | |
| Tuftec H1043 | | | | 2.50 | 4.00 | 10.00 | |
| Total | 100.00 | 100.00 | 100.00 | 100.00 | 100.00 | 100.00 | 100.00 |

For Tables 2 and 3, FEP=fluoroethylene propylene; PPE=poly(phenylene ethynylene); Irganox 1010=Pentaerythritol Tetrakis(3-(3,5-di-tert-butyl-4-hydroxyphenyl)propionate), a sterically hindered phenolic antioxidant; Irgafos 168=Tris (2,4-di-tert-butylphenyl)phosphite, a stabilizer; Kraton G1651=a linear copolymer based on styrene and ethylene/butylene with a polystyrene content of 33%; Sidistar T120=spherically-shaped amorphous dioxide; and Kraton G1650=a clear linear triblock copolymer based on styrene and ethylene/butylene, S-E/B-S, with bound styrene of 29.2% mass.

Tables 3 and 4 show mechanical properties (tested as prescribed by ASTM D638-10, dielectric properties (tested as prescribed by ASTM D150-87, and flame retardancy (LOI tested as prescribed by ASTM D2863-10, and smoke density tested as prescribed by ASTM E662-09) for the compositions described in Tables 2 and 3:

TABLE 3

| | FEP9475 | FT5A1 | FT5A2 | FT5A3 | FT5A4 | FT5A5 | FT5A6 | FT5A7 |
|---|---|---|---|---|---|---|---|---|
| Mechanical Properties | | | | | | | | |
| TENSILE, PSI | 3011.4 | 1671.3 | 1819.2 | 1900.1 | 1841.6 | 1654.9 | 1581.8 | 1978.7 |
| ELONGATION, % | 384.0 | 46.9 | 232.8 | 45.6 | 158.1 | 118.9 | 53.7 | 264.9 |
| Retained Tensile | 83.0 | 112.8 | 114.4 | 105.3 | 134.6 | 135.4 | 125.5 | 109.3 |
| (232° C., 168 hrs), % | | | | | | | | |
| Retained Elongation | 103.8 | 27.3 | 27.8 | 4.4 | 3.5 | 12.6 | 0.0 | 13.4 |
| (232° C., 168 hrs), % | | | | | | | | |
| Dielectric Properties | | | | | | | | |
| Dielectric Constant, | 2.0835 | 2.1514 | 2.1413 | 2.1903 | 2.1928 | 2.1644 | 2.2044 | 2.1526 |
| 1 kHz | | | | | | | | |
| Dielectric Constant, | 2.092 | 2.1573 | 2.1463 | 2.1961 | 2.1975 | 2.1683 | 2.2085 | 2.1581 |
| 1 MHz | | | | | | | | |
| Dielectric Constant, | 2.0781 | 2.1433 | 2.1329 | 2.1818 | 2.1804 | 2.1564 | 2.1982 | 2.1451 |
| 10 MHz | | | | | | | | |
| Dissipation Factor, | 0 | 0 | 0 | 0 | 0 | 0 | 0 | 0 |
| 1 kMz | | | | | | | | |
| Dissipation Factor, | 0.0016 | 0.0016 | 0.0016 | 0.0018 | 0.0016 | 0.0013 | 0.0011 | 0.0015 |
| 1 MHz | | | | | | | | |
| Dissipation Factor, | 0.0614 | 0.0526 | 0.0488 | 0.0563 | 0.0499 | 0.0418 | 0.0384 | 0.0508 |
| 10 MHz | | | | | | | | |
| Flame Retardancy | | | | | | | | |
| Limiting Oxidation Index | >99.9 | >99.9 | >99.9 | >99.9 | >99.9 | >99.9 | 93 | >99.9 |
| (LOI) | | | | | | | | |
| Smoke Density, Flaming | | | | | | | | |
| Mode Application | | | | | | | | |
| Maximum specific optical | 22.31 | 105.88 | 116.23 | 125.49 | 170.39 | 196.94 | 210.73 | 223.1 |
| Density D_{M} | | | | | | | | |
| Smoke Obscuration Indes | 0.1 | 5.3 | 11.1 | 8.5 | 25.9 | 32.5 | 29.3 | 37.4 |
| (Ds = 16) | | | | | | | | |
| Smoke Density, Smoldering | | | | | | | | |
| Mode Application | | | | | | | | |
| Maximum specific optical | 0.39 | 1.44 | 4.03 | 2.54 | 8.72 | 9.73 | 5.57 | 6.15 |
| Density D_{M} | | | | | | | | |
| Smoke Obscuration Indes | Dm < 16 | Dm < 16 | Dm < 16 | Dm < 16 | Dm < 16 | Dm < 16 | Dm < 16 | Dm < 16 |
| (Ds = 16) | | | | | | | | |

TABLE 4

| | FT5A8 | FT5A9 | FT5A10 | FT5A11 | FT5A12 | FTA13 | FT5BA |
|---|---|---|---|---|---|---|---|
| Mechanical Properties | | | | | | | |
| TENSILE, PSI | 1968.7 | 2024.0 | 1793.9 | 1890.7 | 1853.0 | 1758.4 | 2059 |
| ELONGATION, % | 277.7 | 244.1 | 166.7 | 160.9 | 230.6 | 29.3 | 217 |
| Retained Tensile | 127.2 | 106.4 | 136.4 | 127.9 | 128.4 | 108.6 | |
| (232° C., 168 hrs), % | | | | | | | |
| Retained Elongation | 10.4 | 115.2 | 9.2 | 15.2 | 23.8 | 172.3 | |
| (232° C., 168 hrs), % | | | | | | | |
| Dielectric Properties | | | | | | | |
| Dielectric Constant, | 2.1878 | 2.1325 | 2.1788 | 2.1648 | 2.1639 | 2.1399 | 2.1719 |
| 1 kHz | | | | | | | |
| Dielectric Constant, | 2.1943 | 2.1382 | 2.1831 | 2.1691 | 2.1684 | 2.145 | 2.1631 |
| 1 MHz | | | | | | | |
| Dielectric Constant, | 2.1799 | 2.1245 | 2.1712 | 2.1576 | 2.1566 | 2.1276 | 2.1589 |
| 10 MHz | | | | | | | |
| Dissipation Factor, | 0 | 0 | 0 | 0 | 0 | 0 | 0 |
| 1 kMz | | | | | | | |
| Dissipation Factor, | 0.0016 | 0.0015 | 0.0013 | 0.0015 | 0.0014 | 0.0024 | 0.0002 |
| 1 MHz | | | | | | | |
| Dissipation Factor, | 0.0566 | 0.0527 | 0.0433 | 0.0447 | 0.0465 | 0.0736 | 0 |
| 10 MHz | | | | | | | |
| Flame Retardancy | | | | | | | |
| Limiting Oxidation Index | >99.9 | >99.9 | >99.9 | >99.9 | >99.9 | 64.5 | |
| (LOI) | | | | | | | |
| Smoke Density, Flaming | | | | | | | |
| Mode Application | | | | | | | |
| Maximum specific optical | | 180.26 | 295.65 | 258.56 | | | 106.78 |
| Density D_{M} | | | | | | | |
| Smoke Obscuration Indes | | 22.5 | 90.1 | 53.7 | | | 36.9 |
| (Ds = 16) | | | | | | | |
| Smoke Density, Smoldering | | | | | | | |
| Mode Application | | | | | | | |
| Maximum specific optical | | 5.88 | 17.53 | 8.96 | | | 25.46 |
| Density D_{M} | | | | | | | |
| Smoke Obscuration Indes | | Dm < 16 | 0 | Dm < 16 | | | 0 |
| (Ds = 16) | | | | | | | |

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A composition comprising a fluoropolymer, a poly(arylene ether), and a styrene copolymer.

2. The composition of claim 1, where the fluoropolymer resin is present in an amount of at least about 50 weight percent based of the weight of the composition.

3. The composition of claim 1, wherein the fluoropolymer is fluorinated ethylene propylene (FEP), poly(ethylene-co-tetrafluoroethylene) (ETFE), ethylene fluorinated ethylene propylene terpolymer (ETEP), tetrafluoroethylene perfluoromethyl vinyl ether copolymer (MFA), perfluoroalkoxy (PFA), poly(vinylidene fluoride) (PVDF), terpolymer of tetrafluoroethylene hexafluoropropylene vinylidene fluoride (THV), or tetrafluorethylene.

4. The composition of claim 1, where the poly(arylene ether) resin is present in an amount of 1 to 30 weight percent.

5. The composition of claim 1, where the poly(arylene ether) is poly(2,6-dimethyl-1,4-phenylene ether).

6. The composition of claim 1, where the styrene copolymer is present in an amount of 1-20 weight percent.

7. The composition of claim 1, where the styrene copolymer comprising 10-50 weight percent of styrene.

8. The composition of claim 1, where the styrene copolymer may be selected from
a random arrangement of styrene and at least one other block polymer; and/or
a triblock having the formula S-AS-S, wherein S is styrene and A is alkylene or a mixture of different alkylenes.

9. The composition of claim 1, further comprising an antioxidant, a metal deactivator, a flame retarder, a dispersant, a colorant, a filler, a stabilizer, a peroxide, or a lubricant.

10. A method for preparing a composition comprising the step of melt mixing a fluoropolymer, a poly(arylene ether), and a styrene copolymer.

11. The method of claim 10, wherein the melt mixing step takes place in a in Banbury mixer, single screw extruder, twin screw extruder, or Buss kneader.

12. A plenum cable comprising a wire covered with an insulation containing a fluoropolymer, a poly(arylene ether), and a styrene copolymer.

13. The cable of claim 12, where the fluoropolymer resin is present in an amount of at least about 50 weight percent based of the weight of the composition.

14. The cable of claim 12, wherein the fluoropolymer is fluorinated ethylene propylene (FEP), poly(ethylene-co-tetrafluoroethylene) (ETFE), ethylene fluorinated ethylene propylene terpolymer (ETEP), tetrafluoroethylene perfluoromethyl vinyl ether copolymer (MFA), perfluoroalkoxy (PFA), poly(vinylidene fluoride) (PVDF), terpolymer of tetrafluoroethylene hexafluoropropylene vinylidene fluoride (THV), or tetrafluorethylene.

15. The cable of claim 12, where the poly(arylene ether) resin is present in an amount of 1 to 30 weight percent.

16. The cable of claim 12, where the poly(arylene ether) is poly(2,6-dimethyl-1,4-phenylene ether).

17. The cable of claim 12, where the styrene copolymer is present in an amount of 1-20 weight percent.

18. The cable of claim 12, where the styrene copolymer comprising 10-50 weight percent of styrene.

19. The cable of claim 12, where the styrene copolymer may be selected from
a random arrangement of styrene and at least one other block polymer; and/or
a triblock having the formula S-AS-S, wherein S is styrene and A is alkylene or a mixture of different alkylenes.

20. The cable of claim 12, further comprising an antioxidant, a metal deactivator, a flame retarder, a dispersant, a colorant, a filler, a stabilizer, a peroxide, or a lubricant.
